(19) United States
(12) Patent Application Publication
(10) Pub. No.: US 2026/0299381 A1
(43) Pub. Date: Oct. 1, 2026

(54) TELESCOPING TOWER SYSTEM

(71) Applicant: Hi Rise Camera LLC, Frisco, TX (US)

(72) Inventor: Roland Gerod Williams, II, Frisco, TX (US)

(21) Appl. No.: 19/454,801

(22) Filed: Jan. 21, 2026

Related U.S. Application Data
(60) Provisional application No. 63/748,522, filed on Jan. 23, 2025.

(51) Int. Cl. G03B 17/56; F16M 11/20; F16M 11/28; F16M 11/32; F16M 11/42; F16M 13/02

(52) U.S. Cl. CPC G03B 17/561; F16M 11/2014; F16M 11/28; F16M 11/32; F16M 11/42; F16M 13/02; G03B 17/563; F16M 2200/08

(57) ABSTRACT

A telescoping tower system includes a tower to elevate a camera or recording device. The tower may include a telescoping pole, a modular foundation base, a camera shield and housing unit, and a handle. The modular foundation base may be a swivel base, a manual wheel unit, a motorized wheel unit, or a bleacher unit. The telescoping pole may be extendable to different heights. The handle may include a modular handle topper selectively configurable between a foam bar and a remote control bar. The handle may include two wheels that are independently operable and replaceable. The two wheels may each house a tensioned rope that couples the handle to the camera shield and housing unit. The system may include a monitor bracket. The system may include a tripod attachment coupled to the telescoping pole in a tripod configuration of the swivel base.

### CROSS-REFERENCE TO RELATED APPLICATIONS

This application claims priority to and the benefit of U.S. Provisional Patent Application Ser. No. 63/748,522, filed Jan. 23, 2025 and entitled “Telescoping Tower System”, which is incorporated herein by reference for all purposes.

### TECHNICAL FIELD

The present disclosure relates to a telescoping tower system, and more particularly, to a portable telescoping tower system with adjustable components and interchangeable attachments to provide elevated angles for camera and video footage.

### BACKGROUND

Camera tower systems are commonly used for amateur and professional sporting events to capture video footage and still photographs of gameplay from elevated viewpoints. Camera tower systems are often complex, heavy, and expensive systems built as a single unit or with components that are not designed for ease of repair. When built in this manner, camera tower systems traditionally require an end user to replace the entire system or replace an entire component when a single component breaks or malfunctions.

### SUMMARY

The present disclosure relates to a telescoping tower system, and more particularly, to a portable telescoping tower system with adjustable components and interchangeable attachments to provide elevated angles for camera and video footage.

In some implementations, the telescoping tower system includes a telescoping pole, a modular foundation base, a camera shield and housing unit, and a handle. In various implementations, the foundation base may be a swivel base, a manual wheel unit, a motorized wheel unit, or a bleacher unit. The telescoping tower system may further include a monitor bracket.

In another implementation, the telescoping tower system includes means for coupling the system to a fence.

In another implementation, the telescoping tower system includes a tripod attachment coupled to the telescoping pole.

The details of one or more implementations are set forth in the accompanying drawings and the description below. Other features, objects, and advantages of the implementations will be apparent from the description and the drawings.

### BRIEF DESCRIPTION OF THE DRAWINGS

For a more complete understanding of this disclosure and its features, reference is now made to the following description, taken in conjunction with the accompanying drawings, in which:

FIG. 1 illustrates a perspective view of an implementation of a telescoping tower system, according to the present disclosure.

FIG. 2 illustrates a perspective view of an implementation of a foundation base of the telescoping tower system of FIG. 1, according to the present disclosure.

FIG. 3 illustrates a perspective view of an implementation of a handle bracket of the telescoping tower system of FIG. 1, according to the present disclosure.

FIG. 4 illustrates a perspective view of another implementation of a handle bracket of the telescoping tower system of FIG. 1, according to the present disclosure.

FIG. 5 illustrates an expanded view of an implementation of the handle bracket of FIG. 4, according to the present disclosure.

FIG. 6 illustrates a perspective view of an implementation of a monitor bracket of the telescoping tower system of FIG. 1, according to the present disclosure.

FIG. 7A illustrates a perspective view a telescoping pole of the telescoping tower system of FIG. 1, according to the present disclosure.

FIG. 7B illustrates a front view of the telescoping pole of FIG. 7A, depicting nested sections of the telescoping pole collapsed in a base section of the telescoping pole, according to the present disclosure.

FIG. 7C illustrates an expanded, perspective view of a locking clamp of the telescoping pole of FIG. 7A, according to the present disclosure.

FIG. 7D illustrates an expanded, front view of an end portion of the base section of the telescoping pole of FIG. 7A, according to the present disclosure.

FIG. 8A illustrates a perspective view of a camera shield and housing unit of the telescoping tower system of FIG. 1, according to the present disclosure.

FIG. 8B illustrates an expanded, perspective view of an implementation of a stress relief component of the camera shield and housing unit of FIG. 8A, according to the present disclosure.

FIG. 8C illustrates an expanded, perspective view of another implementation of a stress relief component of the camera shield and housing unit of FIG. 8A, according to the present disclosure.

FIG. 9A illustrates a perspective view of a base holder supporting the telescoping tower system of FIG. 1 while resting on its side on the base holder, according to the present disclosure.

FIG. 9B illustrates a perspective view of the base holder shown in FIG. 9A, depicting the base holder in a locked state, according to the present disclosure.

FIG. 9C illustrates a perspective view of the base holder shown in FIG. 9A, depicting the base holder in an unlocked or folded state, according to the present disclosure.

FIG. 10 illustrates a perspective view of another implementation of a foundation base of the telescoping tower system of FIG. 1 comprising a bleacher unit, according to the present disclosure.

FIG. 11 illustrates a perspective view of the telescoping tower system of FIG. 1 coupled to a short fence, according to the present disclosure.

FIG. 12 illustrates a perspective view of the telescoping tower system of FIG. 1 coupled to a tall fence, according to the present disclosure.

FIG. 13 illustrates a perspective view of yet another implementation of a foundation base of the telescoping tower system of FIG. 1 comprising a manual wheel unit, according to the present disclosure.

FIG. 14 illustrates a perspective view of still another implementation of a foundation base of the telescoping tower system of FIG. 1 comprising a motorized wheel unit, according to the present disclosure.

FIG. 15 illustrates a perspective view of yet another implementation of a telescoping tower system, according to the present disclosure.

FIG. 16 illustrates a perspective view of a tripod attachment of the telescoping tower system of FIG. 15, according to the present disclosure.

FIG. 17 illustrates a perspective view of an implementation of a monitor bracket of the telescoping tower system of FIG. 15, according to the present disclosure.

Like reference symbols in the various drawings indicate like elements.

### DETAILED DESCRIPTION

The present disclosure relates to a telescoping tower system, and more particularly, to a portable telescoping tower system with adjustable components and interchangeable attachments to provide elevated angles for camera and video footage.

In various implementations, the telescoping tower system described herein is operable to capture video footage and still photographs of desired subject matter from elevated viewpoints. The multiple adjustable components and interchangeable attachments of the telescoping tower system allow for customization and adaptability to suit a variety of environments, situations, and user needs. The telescoping tower system may be suitable for industrial, commercial, and/or consumer applications. In addition, the modularity of the telescoping tower system allows for uses across a diverse range of industries and for many different purposes, such as sports, hospitality, photography, videography, and security. The modularity also provides for easier transport, storage, and replacement of components and attachments of the telescoping tower system.

A user may tailor the modular telescoping tower system to different scenarios and/or a user's specific needs. For example, the telescoping tower system may be converted from a monopod telescoping tower system to a tripod telescoping tower system by use of a tripod attachment. Additionally, the telescoping tower system may be stationary or fixed in position, mobile via manual or motorized wheels, attached to a bleacher or bleacher bench, and/or attached to fixed objects, such as fences of varying sizes. The telescoping tower system may be operable at variable heights, allowing users to capture video footage and still photographs at a multitude of elevated angles or viewpoints and/or accommodate space limitations or requirements.

The telescoping tower system may also be configured to operate with various types and/or sizes of cameras or recording devices and associated accessories, such as a microphone. A user may control the selected camera or recording device seated on the telescoping tower system by tilting and/or panning a handle bracket of the telescoping tower system. In some implementations, the handle bracket may be configured with a remote control bar, allowing the user to control functionality of the camera or recording device. For example, the remote control bar may allow the user to start, stop, zoom in, zoom out, power on, and/or power off the selected camera or recording device from ground level. The user may attach a viewing monitor or device to the telescoping tower system, allowing the user to view the images or video footage captured from above in real time or near real time. The present disclosure further provides a helpful way of setting or laying down the telescoping tower system when not in use via a holder, as described herein.

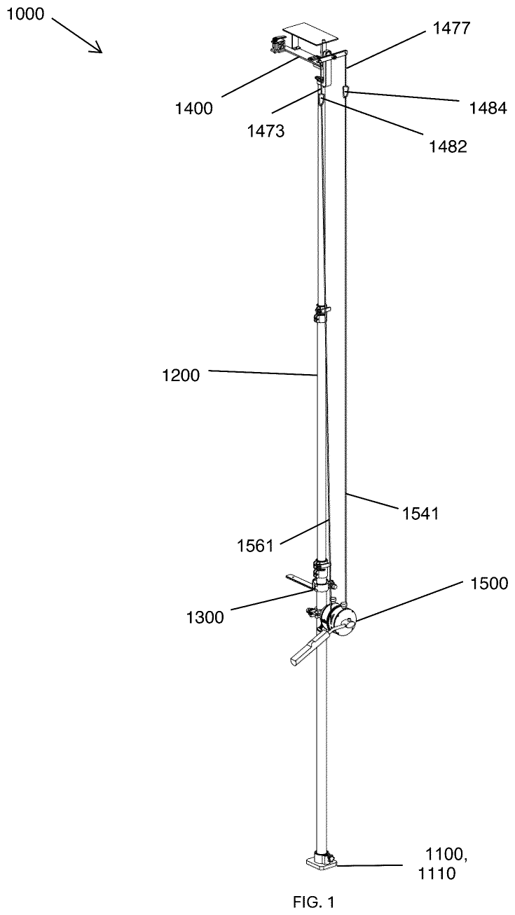

Referring now to the drawings, where like reference numerals represent like components, FIG. 1 illustrates a perspective view of an implementation of a telescoping tower system 1000, according to the present disclosure. The telescoping tower system 1000 comprises a foundation base 1100, such as swivel base 1110. As shown in FIG. 1, a telescoping pole 1200 couples to the foundation base 1100. The telescoping tower system 1000 further comprises several components that couple to the telescoping pole 1200, including a handle bracket 1500, a monitor bracket 1300, and a camera shield and housing unit 1400. The handle bracket 1500 further couples to the camera shield and housing unit 1400 through ropes or cords 1561, 1541 extending upwardly from the handle bracket 1500 coupled to corresponding ropes or cords 1473, 1477 extending downwardly from the camera shield and housing unit 1400 via a means for securing, such as carabiners 1482, 1484.

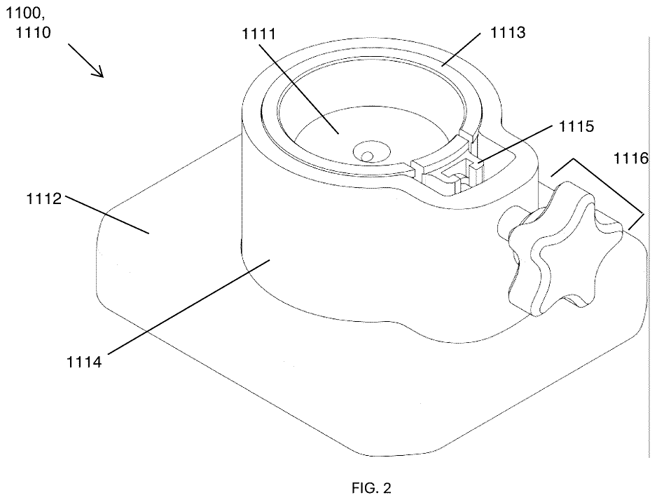

FIG. 2 illustrates swivel base 1110, which is an implementation of the foundation base 1100 of the telescoping tower system 1000 of FIG. 1. The swivel base 1110 comprises a plate 1112 and a tube guide 1114 with means for securing the telescoping pole 1200 to the swivel base 1110, such as bolt and knob assembly 1116. In some implementations, the plate 1112 and tube guide 1114 of the swivel base 1110 may be made of a lightweight, durable material, such as aluminum. Other materials with similar properties may be used. The tube guide 1114 of the swivel base 1110 may comprise a bearing 1111, such as a stainless-steel bearing, to allow for rotation of the telescoping pole 1200 once placed within the tube guide 1114. The tube guide 1114 of swivel base 1110 may further comprise an interior lining 1113 and a tab 1115 to press upon the interior lining 1113. The tab 1115 of the tube guide 1114 of the swivel base 1110 may comprise a gap to receive the means for securing the telescoping pole 1200 to the swivel base 1110. In some implementations, the interior lining 1113 of the tube guide 1114 of the swivel base 1110 may be made of material such as plastic or another material with similar properties. In some implementations, the tab 1115 of the tube guide 1114 of the swivel base 1110 may be made of a lightweight, durable material, such as aluminum. Other materials with similar properties may also be used.

In some implementations, the telescoping pole 1200 may be inserted into the tube guide 1114 of the swivel base 1110 and secured into place by the means for securing. In some implementations, the bolt and knob assembly 1116 may be utilized as the means for securing the telescoping pole 1200 to the swivel base 1110. The bolt and knob assembly 1116 comprises a bolt which may be tightened by turning a knob. As the bolt is tightened against the tab 1115 of the tube guide 1114 of the swivel base 1110, the tab 1115 may exert pressure on the interior lining 1113 of the tube guide 1114 of the swivel base 1110, securing the telescoping pole 1200 into place.

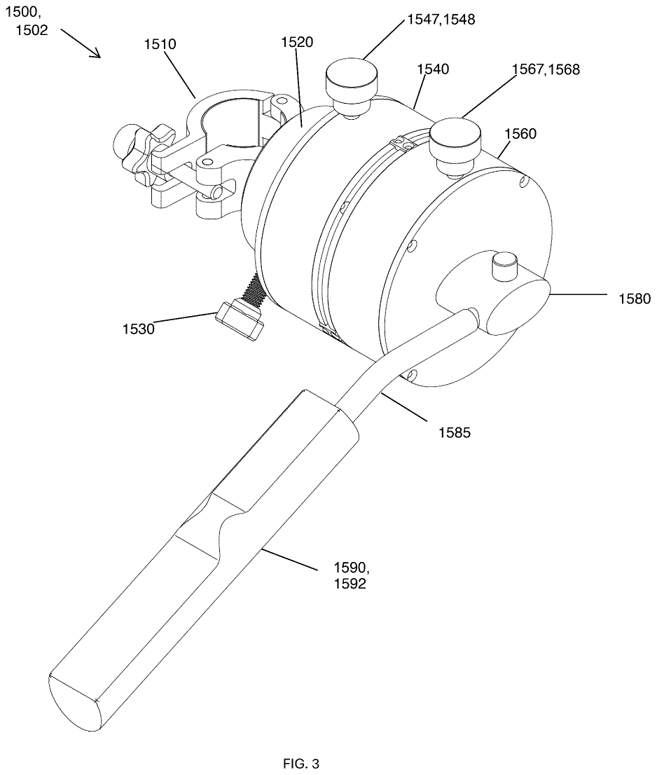

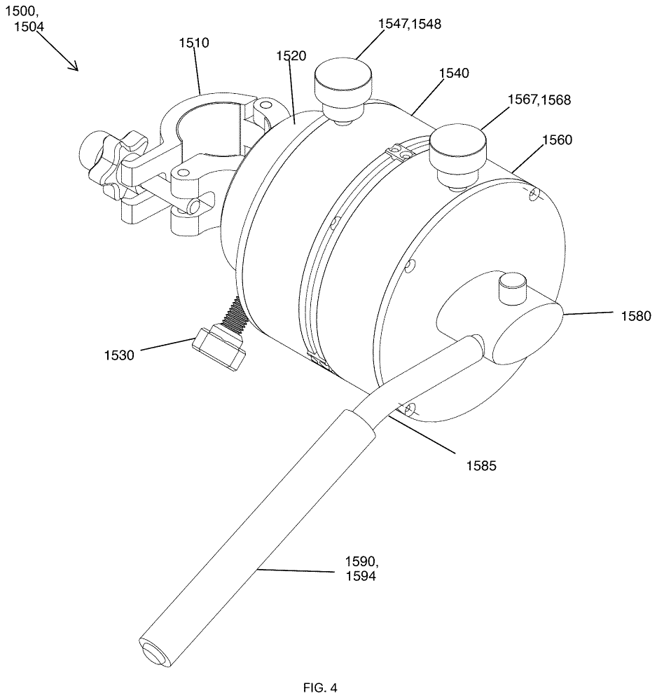

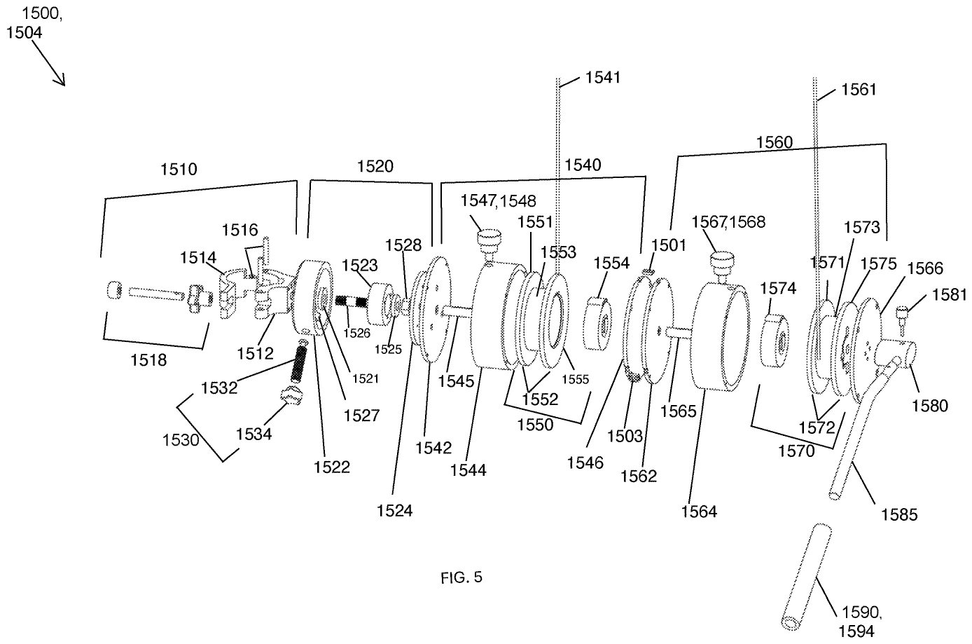

FIGS. 3 and 4 depict various implementations of the handle bracket 1500 of the telescoping tower system 1000 of FIG. 1, namely, a handle bracket with remote control bar 1502 and a handle bracket with foam bar 1504, respectively. In both implementations shown in FIGS. 3 and 4, the handle bracket 1500 may comprise a locking clamp 1510 coupled to an outer wheel 1520 having a brake mechanism 1530. The outer wheel 1520 may couple to a first wheel 1540 that couples to a second wheel 1560. The first wheel 1540 and the second wheel 1560 may each comprise a rope locking mechanism 1548 and 1568, respectively, such as locking knobs 1547, 1567. The second wheel 1560 may couple to a bar adaptor 1580, which may couple to a bar 1585 configured with a handle topper 1590. As illustrated in FIG. 3, the handle bracket with remote control bar 1502 may be configured with the handle topper 1590 comprising a remote control bar 1592. As shown in FIG. 4, the handle bracket with foam bar 1504 may be configured with the handle topper 1590 comprising a foam bar 1594. The handle bracket 1500 will be discussed in further detail infra with respect to the expanded view shown in FIG. 5.

FIG. 5 illustrates an expanded perspective view of an implementation of the handle bracket 1500 of the telescoping tower system 1000 of FIG. 1, depicting the handle bracket with foam bar 1504 of FIG. 4. Notwithstanding differing implementations of the interchangeable handle topper 1590, the remaining components of the handle bracket with remote control bar 1502 and the handle bracket with foam bar 1504 are substantially similar in form and functionality. The locking clamp 1510 of the handle bracket 1500 may have a first arm 1512 and a second arm 1514. The first arm 1512 and the second arm 1514 of the locking clamp 1510 of the handle bracket 1500 may be coupled via a hinge 1516 with a pin. The locking clamp 1510 may further comprise a means for securing the handle bracket 1500 to the telescoping pole 1200. One such means for securing may be a bolt and knob assembly 1518. The bolt and knob assembly 1518 of the locking clamp 1510 may be threaded through the first arm 1512 and the second arm 1514 of the locking clamp 1510. The locking clamp 1510 of the handle bracket 1500 may open and close by pivoting the second arm 1514 of the locking clamp 1510 about the hinge 1516. The second arm 1514 of the locking clamp 1510 of the handle bracket 1500 may be sufficiently opened to allow the telescoping pole 1200 to be positioned between the first arm 1512 and the second arm 1514 of the locking clamp 1510. Then the second arm 1514 of the locking clamp 1510 of the handle bracket 1500 may be closed around the telescoping pole 1200. To secure the handle bracket 1500 to the telescoping pole 1200, the bolt and knob assembly 1518 of the locking clamp 1510 of the handle bracket 1500 may be tightened by rotating the knob such that the bolt may be threaded through the first arm 1512 and the second arm 1514 of the locking clamp 1510.

The locking clamp 1510 of the handle bracket 1500 may couple to the outer wheel 1520 operatively configured to rotate. The outer wheel 1520 of the handle bracket 1500 may comprise an outer wheel housing 1522, an outer wheel plate 1524, and the brake mechanism 1530. In some implementations, the outer wheel housing 1522 may serve as both the housing for internal components of the outer wheel 1520 and the wheel itself. The internal components of the outer wheel 1520 may be housed between the outer wheel housing 1522 and the outer wheel plate 1524. The internal components of the outer wheel 1520 may comprise means for rotation, such as one or more bearings. For example, as depicted in FIG. 5, the outer wheel 1520 of the handle bracket 1500 may comprise a first bearing 1521, a bearing cover 1523, and a second bearing 1525. The first bearing 1521, the bearing cover 1523, and the second bearing 1525 of the outer wheel 1520 may be secured in place via a fastener, such as bolt 1526 and nut 1528. The nut 1528 may be threaded onto the bolt 1526, securing the first bearing 1521, bearing cover 1523, and second bearing 1525 in place between the outer wheel housing 1522 and the outer wheel plate 1524 of the outer wheel 1520.

The internal components of the outer wheel 1520 may further comprise a brake 1527 to slow or stop the rotation of the outer wheel 1520. A user may engage the brake 1527 of the outer wheel 1520 via the brake mechanism 1530. In some implementations, the brake mechanism 1530 may comprise a bolt 1532 and a knob 1534. The brake mechanism 1530 is operable between an engaged state and a disengaged state, or alternatively, between a disengaged state and an engaged state. For example, a user may engage the brake mechanism 1530 by turning the knob 1534, allowing the bolt 1532 to exert pressure against the brake 1527. As the bolt 1532 applies pressure to the brake 1527, the brake 1527 may generate friction, slowing or stopping the rotation of the outer wheel 1520. When sufficient friction is generated, the outer wheel 1520 may stop rotating entirely. A user may disengage the brake mechanism 1530 by turning the knob 1534 in the opposite direction, thereby loosening the bolt 1532, releasing the pressure exerted against the brake 1527 by the bolt 1532, and allowing the outer wheel 1520 to freely rotate.

The outer wheel 1520 may couple to the first wheel 1540. The first wheel 1540 comprises a first wheel housing 1544 positioned between a first cover 1542 and a second cover 1546. As shown in FIG. 5, a spool-spring assembly 1550 may be housed between the first cover 1542, the first wheel housing 1544, and the second cover 1546 of the first wheel 1540. The spool-spring assembly 1550 of the first wheel 1540 may comprise a spool 1552 and a self-retracting spring coil 1554. The spool 1552 of the spool-spring assembly 1550 may comprise a first end cap 1551, a core segment 1553, and a second end cap 1555. In some implementations, the self-retracting spring coil 1554 may be housed within the core segment 1553 of the spool 1552 of the spool-spring assembly 1550. A first end of the self-retracting spring coil 1554 may be configured to anchor to the spool 1552 of the spool-spring assembly 1550 of the first wheel 1540. A second end of the self-retracting spring coil 1554 may be configured to couple to a rope or cord 1541. The rope or cord 1541 may be wound around the exterior of the core segment 1553 of the spool 1552 of the spool-spring assembly 1550 of the first wheel 1540. A free end of the rope or cord 1541 may extend out of the first wheel housing 1544 through an opening. The spool-spring assembly 1550 of the first wheel 1540 may rotate about an axis, such as shaft 1545. The shaft 1545 may also act to secure the spool-spring assembly 1550 in place within the first wheel 1540.

As a user pulls on the free end of the rope or cord 1541 of the first wheel 1540, the spool 1552 of the spool-spring assembly 1550 may rotate about the shaft 1545 and in turn, cause the rope or cord 1541 to unwind from the exterior of the core segment 1553 of the spool 1552. As the rope or cord 1541 unwinds, the self-retracting spring coil 1554 of the spool-spring assembly 1550 may become stretched or unwound. The self-retracting spring coil 1554 of the spool-spring assembly 1550 stores potential energy when it becomes stretched or unwound. The tension in the self-retracting spring coil 1554 of the spool-spring assembly 1550 may increase as a user pulls out more rope or cord 1541 from the first wheel housing 1544. The increase in tension in the self-retracting spring coil 1554 of the spool-spring assembly 1550 causes more energy to be stored in the self-retracting spring coil 1554 and leads to greater resistance when pulling the rope or cord 1541 out of the first wheel 1540.

The first wheel 1540 may further comprise a rope locking mechanism 1548, such as the locking knob 1547. The rope locking mechanism 1548 allows the rope or cord 1541 to remain extended at a desired length, preventing the self-retracting spring coil 1554 from retracting the rope or cord 1541 back into the first wheel housing 1544. For example, the locking knob 1547 may be tightened, applying friction to the spool-spring assembly 1550 of the first wheel 1540. The friction may cause the spool-spring assembly 1550 of the first wheel 1540 to slow down or stop entirely, holding the rope or cord 1541 taut and in place at a desired length. When a user disengages the rope locking mechanism 1548 or releases the rope or cord 1541, the self-retracting spring coil 1554 may gradually begin to recoil or retract. As the self-retracting spring coil 1554 recoils or retracts, the self-retracting spring coil 1554 winds itself back up, releasing the stored potential energy. The release of potential energy stored in the self-retracting spring coil 1554 may cause the spool-spring assembly 1550 of the first wheel 1540 to rotate in the opposite direction, causing the rope or cord 1541 to be pulled back or retracted neatly into the first wheel housing 1544.

The first wheel 1540 may couple to the second wheel 1560. In some implementations, the first wheel 1540 couples to the second wheel 1560 via one or more bridges, such as bridges 1501, 1503. The one or more bridges allow for ease of replacement of either the first wheel 1540, the second wheel 1560, or both the first wheel 1540 and the second wheel 1560 of the handle bracket 1500.

The second wheel 1560 comprises a second wheel housing 1564 positioned between a first cover 1562 and a second cover 1566. As shown in FIG. 5, a spool-spring assembly 1570 may be housed between the first cover 1562, the second wheel housing 1564, and the second cover 1566 of the second wheel 1560. The spool-spring assembly 1570 of the second wheel 1560 may comprise a spool 1572 and a self-retracting spring coil 1574. The spool 1572 of the spool-spring assembly 1570 may comprise a first end cap 1571, a core segment 1573, and a second end cap 1575. In some implementations, the self-retracting spring coil 1574 may be housed within the core segment 1573 of the spool 1572 of the spool-spring assembly 1570. A first end of the self-retracting spring coil 1574 may be configured to anchor to the spool 1572 of the spool-spring assembly 1570 of the second wheel 1560. A second end of the self-retracting spring coil 1574 may be configured to couple to a rope or cord 1561. The rope or cord 1561 may be wound around the exterior of the core segment 1573 of the spool 1572 of the spool-spring assembly 1570 of the second wheel 1560. A free end of the rope or cord 1561 may extend out of the second wheel housing 1564 through an opening. The spool-spring assembly 1570 of the second wheel 1560 may rotate about an axis, such as shaft 1565. The shaft 1565 may also act to secure the spool-spring assembly 1570 in place within the second wheel 1560.

As a user pulls on the free end of the rope or cord 1561, the spool 1572 of the spool-spring assembly 1570 may rotate about the shaft 1565 and in turn, cause the rope or cord 1561 to unwind from the exterior of the core segment 1573 of the spool 1572. As the rope or cord 1561 unwinds, the self-retracting spring coil 1574 of the spool-spring assembly 1570 may become stretched or unwound. The self-retracting spring coil 1574 of the spool-spring assembly 1570 stores potential energy when it becomes stretched or unwound. The tension in the self-retracting spring coil 1574 of the spool-spring assembly 1570 may increase as a user pulls out more rope or cord 1561 from the second wheel housing 1564. The increase in tension in the self-retracting spring coil 1574 of the spool-spring assembly 1570 causes more energy to be stored in the self-retracting spring coil 1574 and leads to greater resistance when pulling the rope or cord 1561 out of the second wheel 1560.

The second wheel 1560 may further comprise a rope locking mechanism 1568, such as the locking knob 1567. The rope locking mechanism 1568 allows the rope or cord 1561 to remain extended at a desired length, preventing the self-retracting spring coil 1574 from retracting the rope or cord 1561 back into the second wheel housing 1564. For example, the locking knob 1567 may be tightened, applying friction to the spool-spring assembly 1570 of the second wheel 1560. The friction may cause the spool-spring assembly 1570 of the second wheel 1560 to slow down or stop entirely, holding the rope or cord 1561 taut and in place at a desired length. When a user disengages the rope locking mechanism 1568 or releases the rope or cord 1561, the self-retracting spring coil 1574 may gradually begin to recoil or retract. As the self-retracting spring coil 1574 recoils or retracts, the self-retracting spring coil 1574 winds itself back up, releasing the stored potential energy. The release of potential energy stored in the self-retracting spring coil 1574 may cause the spool-spring assembly 1570 of the second wheel 1560 to rotate in the opposite direction, causing the rope or cord 1561 to be pulled back or retracted neatly into the second wheel housing 1564.

The second wheel 1560 may couple to bar adaptor 1580. The bar adaptor 1580 may comprise a slot or gap through which the bar 1585 may couple to the bar adaptor 1580. The bar 1585 may be secured within the slot or gap of the bar adaptor 1580 by means of at least one fastener, such as knob 1581. The handle topper 1590 may slide onto the bar 1585. The handle topper 1590 may comprise a variety of interchangeable components. For example, as discussed supra with respect to FIGS. 3 and 4, the handle topper 1590 may comprise the remote control bar 1592 or the foam bar 1594. Other handle topper implementations are also possible.

When taking elevated camera or video footage using the telescoping tower system 1000 of FIG. 1, a user may operatively pan or tilt the handle bracket 1500 shown in FIGS. 3-5 by moving the handle topper 1590 in a desired direction(s). As discussed supra with respect to FIG. 1, the handle bracket 1500 couples to the camera shield and housing unit 1400 through the ropes or cords 1541, 1561 that extend from the first wheel 1540 and the second wheel 1560 coupled to means for securing, such as carabiners 1482, 1484, which in turn couple to ropes or cords 1473, 1477 that extend from the camera shield and housing unit 1400. As a result, movement of the handle bracket 1500 causes substantially similar movement at substantially the same time with respect to the camera shield and housing unit 1400. When the handle bracket with remote control bar 1502 is employed as the handle bracket 1500 of the telescoping tower system 1000, a user may control the functions of the camera or recording device with the remote control bar 1592. In various implementations, to control functionality via the remote control bar 1592, a cable or cord may connect the remote control bar 1592 and the camera or recording device seated within the camera shield and housing unit 1400, or the remote control bar 1592 may be configured to communicate wirelessly with the camera or recording device seated within the camera shield and housing unit 1400. The remote control bar 1592 may allow a user to start and/or stop the camera or recording device, zoom in and/or out, and power the camera or recording device on and/or off, for example. The remote control bar 1592 may have other capabilities.

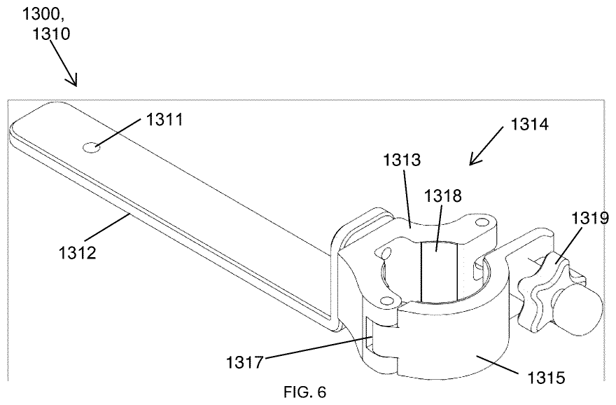

FIG. 6 depicts an implementation of a monitor bracket 1300 of the telescoping tower system 1000 of FIG. 1, which is a monopod monitor bracket 1310. The monopod monitor bracket 1310 comprises an L bracket 1312 coupled to a clamp 1314 comprising a first arm 1313 and a second arm 1315. The L bracket 1312 may comprise means for coupling a monitor to the monopod monitor bracket 1310, such as hole 1311. In some implementations, the L bracket 1312 may be coupled to the first arm 1313 of the clamp 1314 via a fastener, such as a bolt. The first arm 1313 and the second arm 1315 of the clamp 1314 of the monopod monitor bracket 1310 may be coupled via a hinge 1317 with a pin. An interior portion of the first arm 1313 and the second arm 1315 of the clamp 1314 may comprise padding 1318 to provide grip.

As shown in FIG. 6, the clamp 1314 may further comprise means for securing the monopod monitor bracket 1310 to the telescoping pole 1200, such as a bolt and knob assembly 1319 with an end cap. The bolt and knob assembly 1319 may be threaded through the first arm 1313 and the second arm 1315 of the clamp 1314. The clamp 1314 of the monopod monitor bracket 1310 may open and close by pivoting the second arm 1315 of the clamp 1314 about the hinge 1317. The second arm 1315 of the clamp 1314 of the monopod monitor bracket 1310 may be sufficiently opened to allow the telescoping pole 1200 to be positioned between the first arm 1313 and the second arm 1315 of the clamp 1314. The second arm 1315 of the clamp 1314 of the monopod monitor bracket 1310 may then be closed around the telescoping pole 1200. To secure the monopod monitor bracket 1310 to the telescoping pole 1200, the bolt and knob assembly 1319 of the clamp 1314 of the monopod monitor bracket 1310 may then be tightened by threading a bolt through the first arm 1313 and the second arm 1315 of clamp 1314.

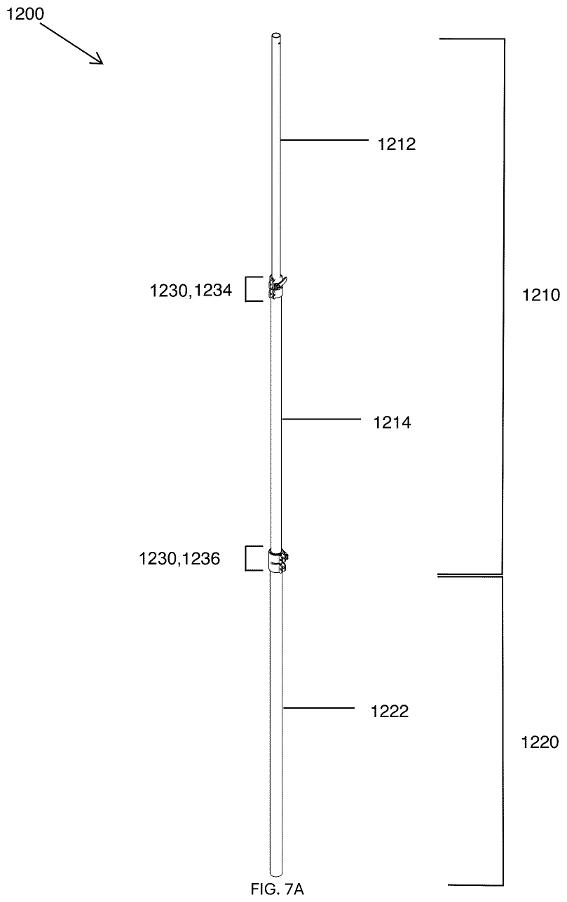

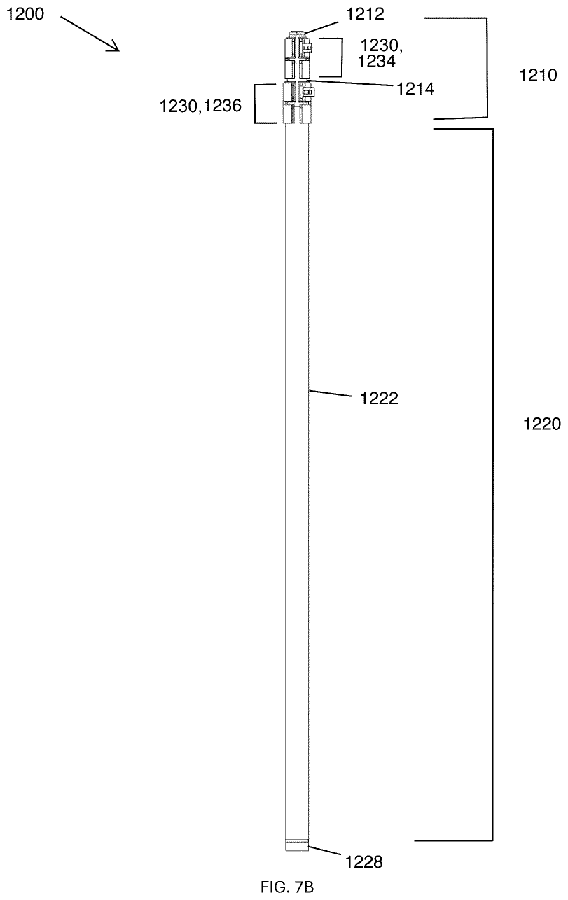

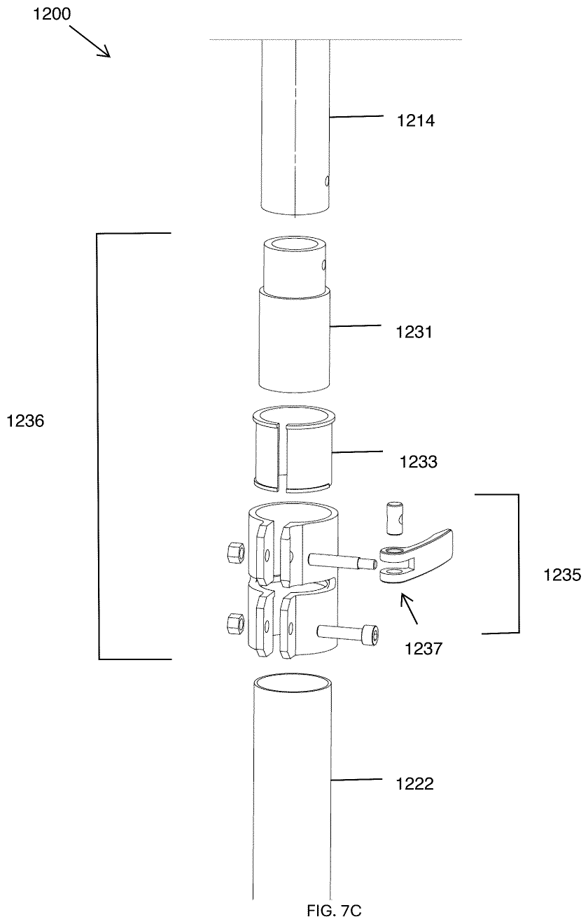

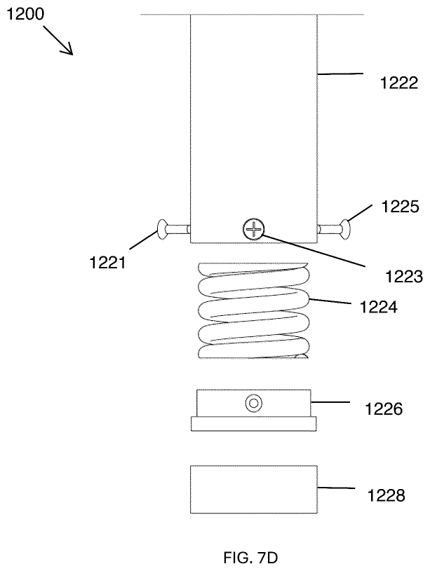

The monopod monitor bracket 1310 may be adjusted vertically along the length of the telescoping pole 1200 and/or may be rotated vertically about the telescoping pole 1200 prior to securing the monopod monitor bracket 1310 to the telescoping pole 1200. The monopod monitor bracket 1310 may vary in size depending, at least in part, on the height of the telescoping pole 1200, described in further detail infra with respect to FIGS. 7A through 7D. In some implementations, the L bracket 1312, the first arm 1313 and the second arm 1315 of the clamp 1314 of the monopod monitor bracket 1310 may be made of aluminum or other similar materials. The bolt and knob assembly 1319 may be made of steel, aluminum, and/or other similar materials. The padding 1318 on the interior of the first arm 1313 and the second arm 1315 of the clamp 1314 may be made of a material such as plastic.

FIGS. 7A through 7D illustrate perspective and front views of the adjustable telescoping pole 1200, according to the present disclosure. As best depicted in FIG. 7A, the telescoping pole 1200 comprises one or more nested sections 1210 and a base section 1220. The one or more nested sections 1210 of the telescoping pole 1200 may each be adjusted through an extension mechanism 1230, such as locking clamps 1234, 1236, to extend the length of each of the one or more nested sections 1210. As best shown in FIG. 7B, the one or more nested sections 1210 of the telescoping pole 1200 may partially or fully collapse into a wider nested section or base section 1220 through the extension mechanism 1230.

In some implementations, the telescoping pole 1200 may comprise a top pole 1212 coupled to a second pole 1214 via an extension mechanism 1230, such as a small locking clamp 1234, and the second pole 1214 may be coupled to a bottom pole 1222 via an extension mechanism 1230, such as a large locking clamp 1236. As shown in FIG. 7A, the base section 1220 comprises the wider bottom pole 1222 of the telescoping pole 1200, while the one or more nested sections 1210 comprise the slightly narrower second pole 1214 and the even narrower top pole 1212 of the telescoping pole 1200. The larger diameter of the bottom pole 1222 of the telescoping pole 1200 may allow the slightly narrower second pole 1214 and the even narrower top pole 1212 of the telescoping pole 1200 to fit within (or inside) the bottom pole 1222 of the telescoping pole 1200 when the one or more nested sections 1210 are partially or fully collapsed via the extension mechanisms 1230.

FIG. 7A depicts the small locking clamp 1234 coupling the top pole 1212 to the second pole 1214 of the telescoping pole 1200 and the large locking clamp 1236 coupling the second pole 1214 to the bottom pole 1222 of the telescoping pole 1200. The small and large locking clamps 1234 and 1236, respectively, differ only in their respective sizes but are otherwise substantially similar in form and function. As best depicted in FIG. 7C, the large locking clamp 1236 may comprise at least one pole joint 1231, an interior lining 1233, and a clamp body 1235. The at least one pole joint 1231 provides stability to the telescoping pole 1200. The clamp body 1235 may comprise means for securing and adjusting the length of the one or more nested sections 1210 of the telescoping pole 1200, such as a fastener 1237. For example, FIG. 7A illustrates the small locking clamp 1234 and the large locking clamp 1236 of the telescoping pole 1200 each having the clamp body 1235 comprising a nut and bolt assembly with a hinged lever and a nut and bolt assembly without one. When the hinged lever of the small locking clamp 1234 and/or the large locking clamp 1236 is in an opened or unlocked state, a user may freely extend or collapse each of the one or more nested sections 1210 of the telescoping pole 1200 to a desired height. To secure or lock the one or more nested sections 1210 of the telescoping pole 1200 into place, a user may engage the hinged lever which may allow the small locking clamp 1234 and/or the large locking clamp 1236 to tighten around and exert pressure on the one or more nested sections 1210 of the telescoping pole 1200.

As best depicted in FIG. 7D, an interior of an end portion of the bottom pole 1222 of the telescoping pole 1200 may house a spring 1224 that rests upon a pole base adaptor 1226. The spring 1224 and pole base adaptor 1226 may be secured within the interior of the end portion of the bottom pole 1222 of the telescoping pole 1200 via one or more bolts threaded through the exterior of the bottom pole 1222 of the telescoping pole 1200, such as bolts 1221, 1223, 1225. As best illustrated in FIGS. 7B and 7D, the end portion of the bottom pole 1222 of the telescoping pole 1200 may further comprise a rubber pad 1228.

In some implementations, the telescoping pole 1200 may extend up to twelve (12) feet. In other implementations, the telescoping pole 1200 may extend up to twenty-one (21) feet. The one or more nested sections 1210, the base section 1220, and the at least one pole joint 1231 of the telescoping pole 1200 may be made of a lightweight, durable material, such as aluminum or carbon fiber. Other materials having similar properties may be selected.

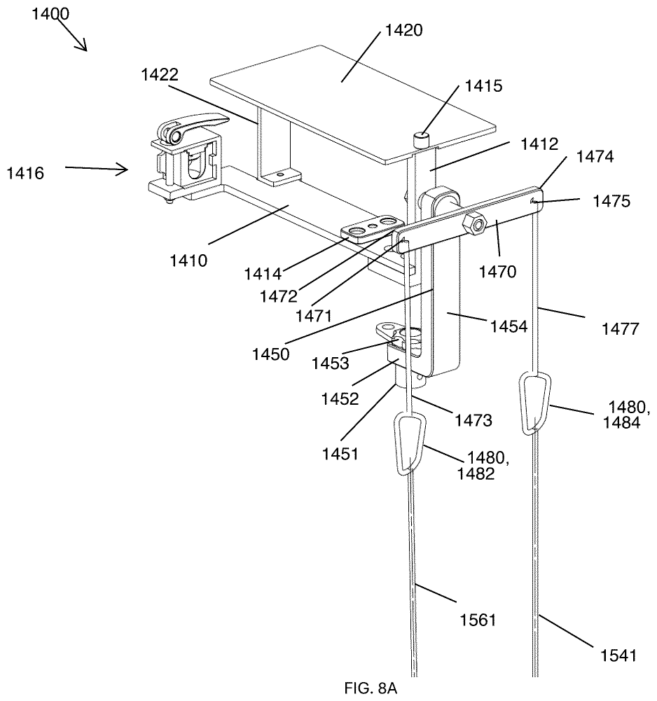

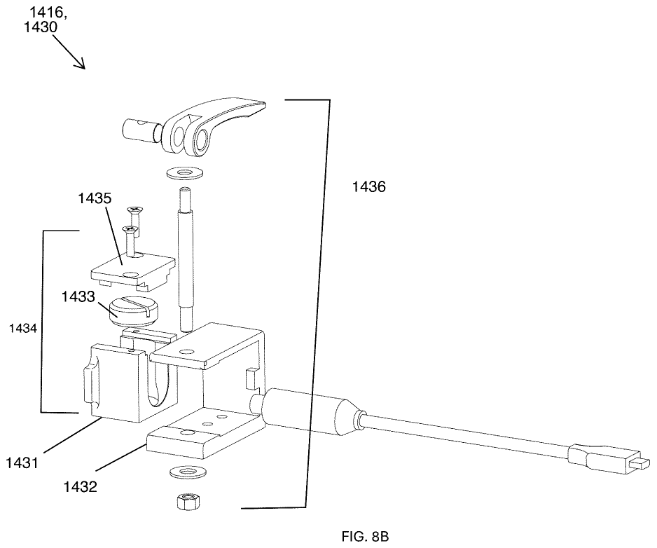

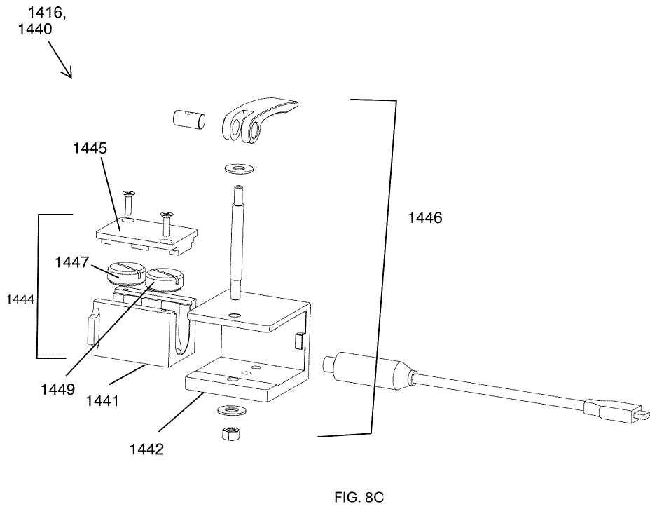

FIG. 8A illustrates a camera shield and housing unit 1400 of the telescoping tower system 1000 of FIG. 1. The camera shield and housing unit 1400 may comprise a bottom plate 1410 coupled to a top shield 1420. In some implementations, one end of the bottom plate 1410 of the camera shield and housing unit 1400 may have an L-shaped support bracket 1412. Likewise, one end of the top shield 1420 of the camera shield and housing unit 1400 may have an L-shaped support bracket 1422. The L-shaped support bracket 1412 of the bottom plate 1410 of the camera shield and housing unit 1400 may couple to the top shield 1420 of the camera shield and housing unit 1400 by means of a fastener 1415. The L-shaped support bracket 1422 of the top shield 1420 of the camera shield and housing unit 1400 may couple to the bottom plate 1410 of the camera shield and housing unit 1400 by means of a fastener.

The bottom plate 1410 of the camera shield and housing unit 1400 may further comprise means for securely seating a camera or recording device, such as a camera seat 1414. In some implementations, the top shield 1420 of the camera shield and housing unit 1400 may be removeable to allow for larger cameras or recording devices to be securely seated on the camera shield and housing unit 1400.

The bottom plate 1410 of the camera shield and housing unit 1400 may further comprise a means for stress relief and/or protection of a user's connected cables or cords, if any, such as a stress relief component 1416. For example, by reducing the stress on a cable or cord connected to a camera or recording device seated within the camera shield and housing unit 1400, the stress relief component 1416 may protect the cable or cord from bending or breaking off. The stress relief component 1416 may vary depending, at least in part, on the maximum extension of the telescoping pole 1200 of the telescoping tower system 1000.

The L-shaped support bracket 1412 of the bottom plate 1410 of the camera shield and housing unit 1400 may couple to an L bracket 1450 having a foot 1452 and stem 1454. The foot 1452 of the L bracket 1450 may further comprise a pole guide 1451 and fastener 1453 to allow the camera shield and housing unit 1400 to couple to the telescoping pole 1200. The stem 1454 of the L bracket 1450 of the camera shield and housing unit 1400 may further couple to a bar, such as T bar 1470. As shown in FIG. 8A, a first end 1472 of the T bar 1470 of the camera shield and housing unit 1400 may have at least one hole 1471 through which a rope or cord 1473 may be inserted. Similarly, a second end 1474 of the T bar 1470 of the camera shield and housing unit 1400 may have at least one hole 1475 through which a rope or cord 1477 may be inserted. The ropes or cords 1473, 1477 of the camera shield and housing unit 1400 may couple to fasteners 1480, such as carabiners 1482, 1484. The fasteners 1480 allow the ropes or cords 1473, 1477 of the camera shield and housing unit 1400 to couple to the ropes or cords 1541, 1561 of the handle bracket 1500.

The top shield 1420 of the camera shield and housing unit 1400 may provide the camera or recording device shade and/or may deflect light to prevent glare in the video footage or still photographs. In some implementations, the camera shield and housing unit 1400 may vary in size—but not in form and/or function—depending, at least in part, on the maximum extension of the telescoping pole 1200 of the telescoping tower system 1000.

FIG. 8B illustrates an implementation of the stress relief component 1416, such as a short stress relief component 1430. In implementations of the telescoping tower system 1000 where the telescoping pole 1200 of the telescoping tower system 1000 extends up to twelve (12) feet, the short stress relief component 1430 may be utilized. The short stress relief component 1430 comprises a camera shield track 1432. The camera shield track 1432 couples to the bottom plate 1410 of the camera shield and housing unit 1400. The camera shield track 1432 of the short stress relief component 1430 further comprises a chamber unit 1434 through which a cable or cord may be housed. The chamber unit 1434 of the short stress relief component 1430 of the camera shield and housing unit 1400 comprises a chamber body 1431, a tension tab 1433, and a chamber cover 1435. A cable or cord may be inserted through the chamber unit 1434 and held in place within the chamber unit 1434 via the tension tab 1433. The chamber unit 1434 may be secured within the camera shield track 1432 of the short stress relief component 1430 by means of a fastener, such as a bolt and hinged lever assembly 1436.

FIG. 8C illustrates another implementation of the stress relief component 1416, such as a tall stress relief component 1440. In implementations of the telescoping tower system 1000 where the telescoping pole 1200 of the telescoping tower system 1000 extends up to twenty-one (21) feet, the tall stress relief component 1440 may be utilized. The tall stress relief component 1440 may be substantially similar to the short stress relief component 1430 described supra. Namely, the tall stress relief component 1440 may comprise a camera shield track 1442, a chamber unit 1444 having a chamber body 1441, at least one tension tab 1443 and a chamber cover 1445, and a fastener, such as a bolt and hinged lever assembly 1446. However, key differences will be described. For example, the camera shield track 1442 of the tall stress relief component 1440 may be greater in length than the camera shield track 1432 of the short stress relief component 1430 described supra. Similarly, the chamber unit 1444 of the tall stress relief component 1440 may be greater in length than the chamber unit 1434 of the short stress relief component 1430 described supra. In addition, the tall stress relief component 1440 may comprise more than one tension tab 1443, such as tabs 1447, 1449.

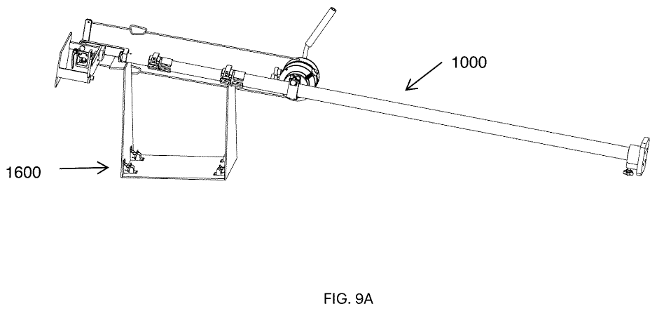

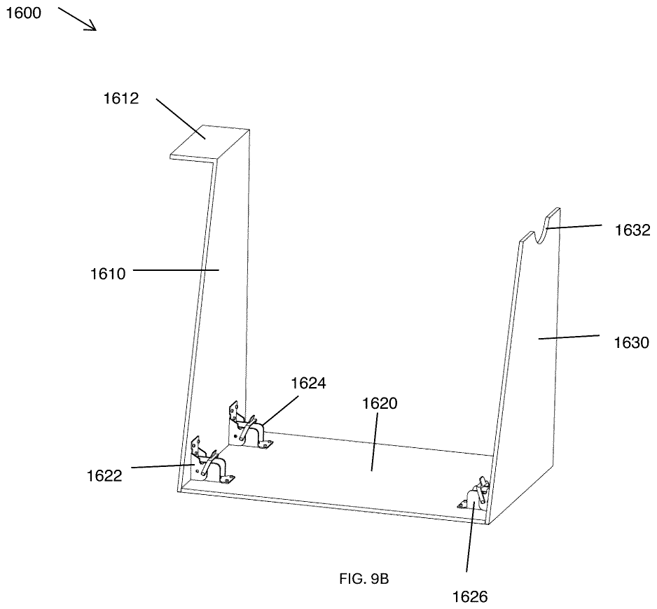

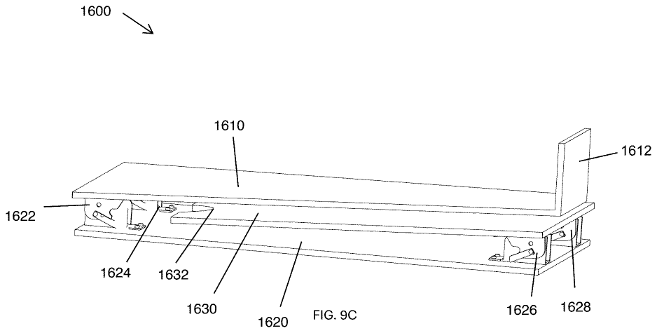

FIGS. 9A through 9C illustrate a base holder 1600 designed to support the telescoping tower system 1000 of FIG. 1 in a resting position on its side rather than laying the telescoping tower system 1000 on the ground. As best depicted in FIG. 9B, the base holder 1600 comprises a bracket plate 1610, a bottom plate 1620, and a clamp plate 1630. In some implementations, the bracket plate 1610 of the base holder 1600 may have an L-shape with the foot of the “L” comprising a flat surface 1612 upon which the camera shield and housing unit 1400 of the telescoping tower system 1000 may rest. One end of the clamp plate 1630 of the base holder 1600 may have a slot 1632 upon which the telescoping pole 1200 of the telescoping tower system 1000 may rest. The bracket plate 1610 of the base holder 1600 may couple to one end of the bottom plate 1620 of the base holder 1600 via one or more hinges, such as hinges 1622, 1624. Similarly, the clamp plate 1630 of the base holder 1600 may couple to the opposite end of the bottom plate 1620 of the base holder 1600 via one or more hinges, such as hinges 1626, 1628. The one or more hinges coupling the bracket plate 1610 to the bottom plate 1620 and the clamp plate 1630 to the bottom plate 1620 are substantially similar in form and functionality. In some implementations, the hinges 1622, 1624, 1626, 1628 may lock to allow for use of the base holder 1600 and may unlock to provide for easier storage and transport of the base holder 1600.

FIG. 9B illustrates the base holder 1600 of FIG. 9A in a locked state. When the hinges 1622, 1624, 1626, 1628 (not shown) are in a locked state, the bracket plate 1610 and the clamp plate 1630 may be oriented vertically and/or substantially perpendicular to the bottom plate 1620. In the locked state, a user may rest the telescoping tower system 1000 upon the base holder 1600, as shown in FIG. 9A.

FIG. 9C illustrates the base holder 1600 of FIG. 9A in an unlocked or folded state. When the hinges 1622, 1624, 1626, 1628 are in an unlocked state, the bracket plate 1610 and the clamp plate 1630 may each be lowered inward to rest horizontally or substantially parallel to the bottom plate 1620. In an implementation, the clamp plate 1630 may be lowered inward first before the bracket plate 1610 is lowered inward to the position shown in FIG. 9C.

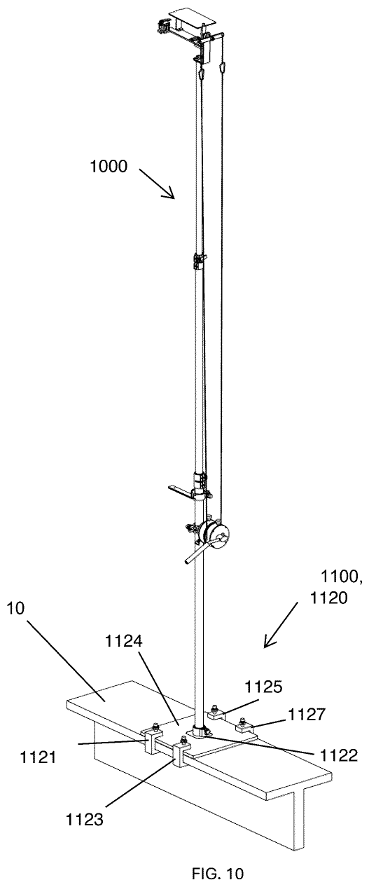

As depicted in FIG. 10, the telescoping tower system 1000 of FIG. 1 may be coupled to another implementation of the foundation base 1100, such as a bleacher unit 1120. The bleacher unit 1120 may be coupled to a bleacher or bleacher bench 10, which may include gym bleachers, stadium bleachers, field stands, or other similar types of seating. In some implementations, the bleacher unit 1120 may comprise a swivel base 1122 coupled to a base plate 1124. In other implementations, the swivel base 1122 may be integrated into the base plate 1124. The base plate 1124 of the bleacher unit 1120 may further comprise means for securing the bleacher unit 1120 to a bleacher or bleacher bench 10, which may be adjustable to suit a variety of bleacher and/or bleacher bench types and/or sizes. For example, the means for securing the bleacher unit 1120 to a bleacher or bleacher bench 10 may comprise one or more clamps each having a latch mechanism, such as clamps 1121, 1123, 1125, 1127. The latch mechanism of the clamps 1121, 1123, 1125, 1127 may allow for a user to operably adjust the tightness of each of the one or more clamps.

The latch mechanism may comprise a latch having a locking pin with a knob or lever. The knob or lever of the latch mechanism may be adjustable along a track or slot. In some implementations, the track or slot may be integrated into the base plate 1124 of the bleacher unit 1120. The locking pin with the knob or lever may operably slide along the track or slot and lock the bleacher unit 1120 into a variety of positions depending, at least in part, on the width of the bleacher or bleacher bench.

To secure the bleacher unit 1120 to a bleacher or bleacher bench 10, the latch mechanism may be employed by rotating the knob or lever. When a user rotates the knob or lever, the locking pin may move along the track or slot. After determining an appropriate position, a user may lock the locking pin into place by rotating the knob or lever, to engage a locking mechanism to secure the locking pin. In some implementations, the locking mechanism may comprise a spring-loaded mechanism to secure the locking pin. In other implementations, the locking mechanism may comprise a threaded component that secures the locking pin.

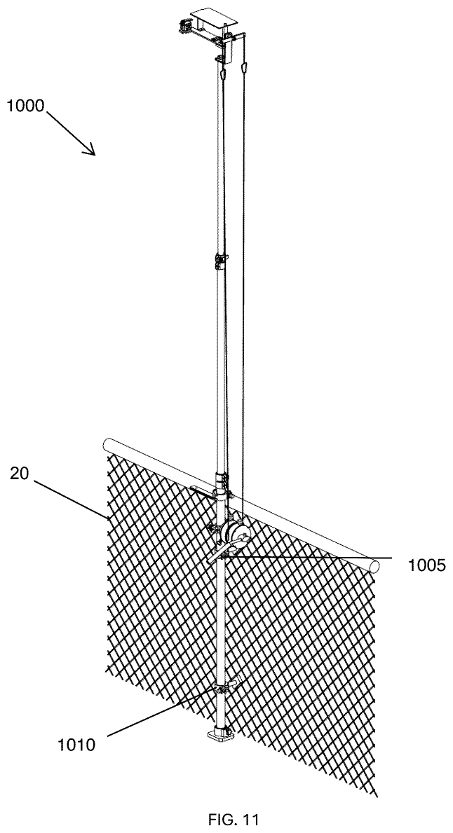

FIG. 11 depicts the telescoping tower system 1000 of FIG. 1 coupled to a short fence 20. The telescoping tower system 1000 may couple to the short fence 20 by means of one or more fasteners, such as a first fence clamp 1005 and a second fence clamp 1010. As shown in FIG. 11, the first fence clamp 1005 and the second fence clamp 1010 couple to both the telescoping pole 1200 and the short fence 20.

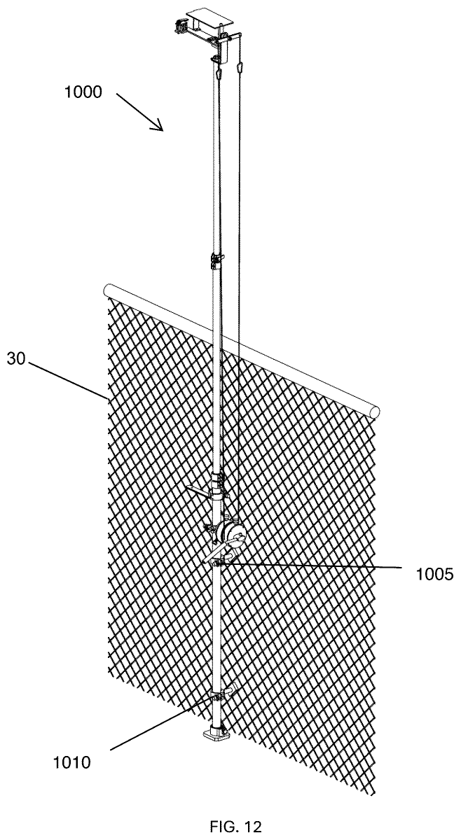

Similarly, FIG. 12 illustrates the telescoping tower system 1000 of FIG. 1 coupled to a tall fence 30. The telescoping tower system 1000 may couple to the tall fence 30 by means of one or more fasteners, such as the first fence clamp 1005 and the second fence clamp 1010. As depicted in FIG. 12, the first fence clamp 1005 and the second fence clamp 1010 couple to both the telescoping pole 1200 and the tall fence 30.

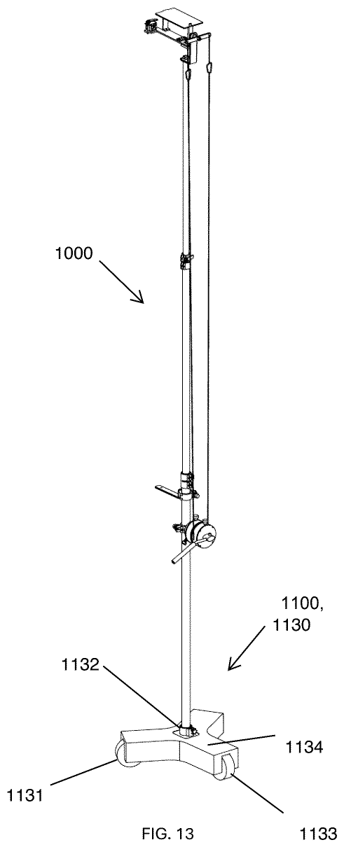

As shown in FIG. 13, the telescoping tower system 1000 of FIG. 1 may be coupled to another implementation of the foundation base 1100, such as a manual wheel unit 1130. In some implementations, the manual wheel unit 1130 comprises an internal swivel base 1132 coupled to a base 1134 with one or more wheels, such as wheels 1131, 1133. In other implementations, the internal swivel base 1132 may be integrated into the base 1134. As shown in FIG. 13, the telescoping pole 1200 couples to the manual wheel unit 1130 via the internal swivel base 1132 of the manual wheel unit 1130. The one or more wheels 1131, 1133 of the manual wheel unit 1130 may be operable on many different types of terrain, including both indoor and outdoor terrain.

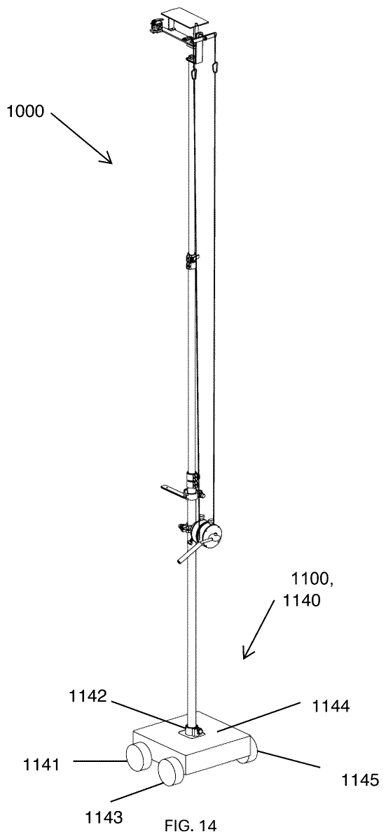

FIG. 14 depicts the telescoping tower system 1000 of FIG. 1 coupled to yet another implementation of the foundation base 1100, such as a motorized wheel unit 1140. In some implementations, the motorized wheel unit 1140 comprises an internal swivel base 1142 coupled to an outer shell base 1144. In other implementations, the internal swivel base 1142 may be integrated into the outer shell base 1144. The outer shell base 1144 of the motorized wheel unit 1140 comprises a remote control sensor and one or more wheels, such as wheels 1141, 1143, 1145. As illustrated in FIG. 14, the telescoping pole 1200 couples to the motorized wheel unit 1140 via the internal swivel base 1142 of the motorized wheel unit 1140. The one or more wheels 1141, 1143, 1145 of the motorized wheel unit 1140 may be operable on many different types of terrain, including both indoor and outdoor terrain. In some implementations, a user may control the directional movement of the motorized wheel unit 1140 via mobile application commands.

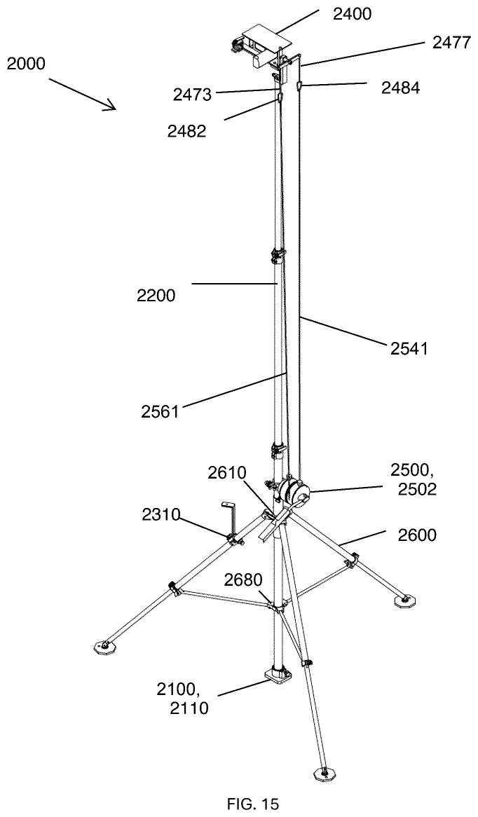

FIG. 15 illustrates a perspective view of another implementation of a telescoping tower system 2000. Like the telescoping tower system of FIG. 1, the telescoping tower system 2000 comprises a foundation base 2100, such as swivel base 2110. As shown in FIG. 15, a first end of a telescoping pole 2200 couples to the swivel base 2110. A camera shield and housing unit 2400 couples to a second end of the telescoping pole 2200. The telescoping tower system 2000 further comprises a handle bracket 2500, such as handle bracket with remote control bar 2502. The handle bracket 2500 couples to the camera shield and housing unit 2400 through ropes or cords 2561, 2541 extending upwardly from the handle bracket 2500 coupled to corresponding ropes or cords 2473, 2477 extending downwardly from the camera shield and housing unit 2400 via a means for securing, such as carabiners 2482, 2484. The foundation base 2100, telescoping pole 2200, camera shield and housing unit 2400, and handle bracket 2500 of the telescoping tower system 2000 may be substantially similar in form and function to the foundation base 1100, telescoping pole 1200, camera shield and housing unit 1400, and handle bracket 1500 described supra with respect to FIGS. 1 through 14. The telescoping tower system 2000 may further comprise a tripod attachment 2600 which couples to the telescoping pole 2200, and a monitor bracket 2300, such as tripod monitor bracket 2310, that couples to the tripod attachment 2600.

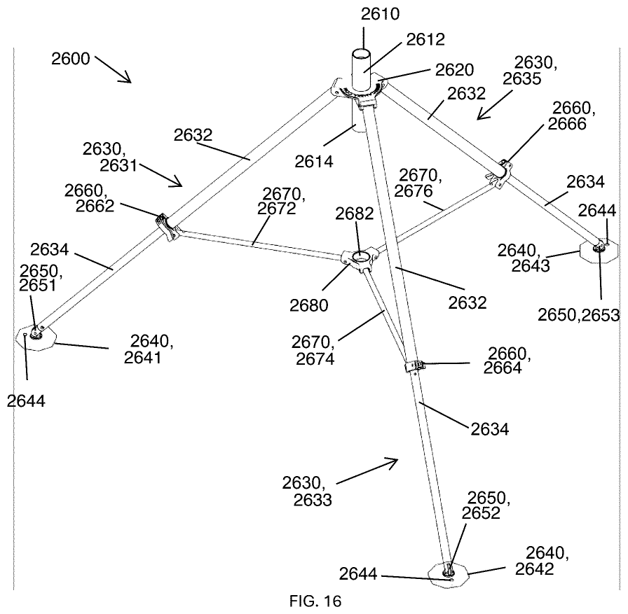

As depicted in FIG. 16, the tripod attachment 2600 may comprise a top pole guide 2610 through which the telescoping tower system 2000 may be inserted. The top pole guide 2610 may comprise a top tube 2612 and a bottom tube 2614. The top tube 2612 of the top pole guide 2610 may couple to the bottom tube 2614 of the top pole guide 2610 via a connector plate 2620. The connector plate 2620 may further comprise a level to ensure the tripod attachment 2600, camera or recording device, and/or telescoping tower system 2000 is level. The top tube 2612 of the top pole guide 2610 of the tripod attachment 2600 may further comprise an interior lining, such as a plastic lining. Similarly, the bottom tube 2614 of the top pole guide 2610 of the tripod attachment 2600 may further comprise an interior lining, such as a plastic lining. The tripod attachment 2600 may further comprise at least three legs 2630, such as legs 2631, 2633, 2635. The at least three legs 2630 of the tripod attachment 2600 couple to the connector plate 2620 of the tripod attachment 2600, with the at least three legs 2630 extending out from the connector plate 2620.

Each of the at least three legs 2630 of the tripod attachment 2600 comprises an upper portion 2632 and a lower portion 2634. The lower portion 2634 of each of the at least three legs 2630 of the tripod attachment 2600 couples to a foot 2640, such as feet 2641, 2642, 2643. Each foot 2640 may further comprise a tab 2650, such as tabs 2651, 2652, 2653. In some implementations, the tab 2650 may be integrated into the foot 2640. In other implementations, the tab 2650 may couple to the foot 2640. Each foot 2640 of the tripod attachment 2600 may further comprise means for securing the telescoping tower system 2000 to the ground and/or for providing additional stability, such as a hole or slot 2644. For example, the telescoping tower system 2000 may be secured to the ground via stakes or anchor bags secured through the hole or slot 2644 of each foot 2640 of the tripod attachment 2600.

The upper portion 2632 of each of the at least three legs 2630 of the tripod attachment 2600 may couple to the lower portion 2634 of each of the at least three legs 2630 of the tripod attachment 2600 through a leg connector 2660. Each of the at least three leg connectors 2660 of the tripod attachment 2600 provide means for adjusting and securing the height of the tripod attachment 2600. As shown in FIG. 16, each of the at least three leg connectors 2660 of the tripod attachment 2600 may be clamps, such as clamps 2662, 2664, 2666. Each of the at least three leg connectors 2660 of the tripod attachment 2600 may further comprise an inner arm 2670 to provide additional stability, such as inner arms 2672, 2674, 2676. Each of the at least three inner arms 2670 of the tripod attachment 2600 converge and couple to a lower pole guide 2680. The lower pole guide 2680 of the tripod attachment 2600 sits below and is substantially aligned with the top pole guide 2610 of the tripod attachment 2600. Like the top pole guide 2610, the lower pole guide 2680 of the tripod attachment may further comprise an interior lining 2682, such as a plastic lining. In some implementations, the inner arms 2672, 2674, 2676 may further comprise means for securing and/or stabilizing the telescoping tower 2000, such as a hole or slot (not shown) through which anchor bags may be hung.

As best depicted in FIG. 15, the tripod attachment 2600 may couple to the telescoping pole 2200 of the telescoping tower system 2000. The telescoping pole 2200 may be inserted through the top pole guide 2610 and the lower pole guide 2680 of the tripod attachment 2600. The at least three legs 2630 of the tripod attachment 2600 may each be adjusted to a desired height by extending or collapsing each leg via each of the at least three leg connectors 2660. The independent adjustability of the at least three legs 2630 of the tripod attachment 2600 may allow a user to utilize the telescoping tower system 2000 on many different types of terrain, including uneven terrain.

Each of the at least three legs 2630, each of the at least three inner arms 2670, each foot 2640 and tab 2650, the top pole guide 2610, and the lower pole guide 2680 of the tripod attachment 2600 may be made of a lightweight, durable material. One such material is aluminum. Other materials having similar properties may be selected.

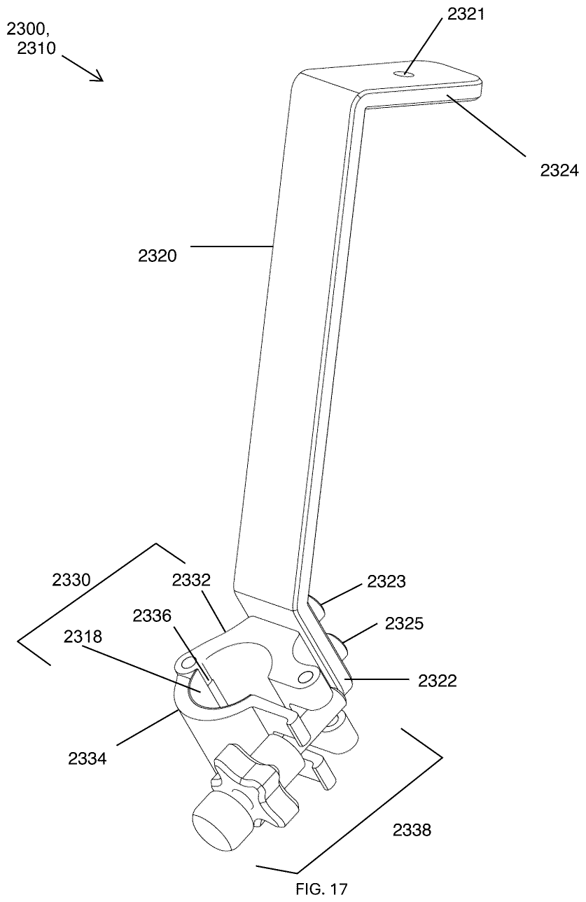

FIG. 17 depicts another implementation of a monitor bracket 2300, such as the tripod monitor bracket 2310, of the telescoping tower system 2000 of FIG. 15. The tripod monitor bracket 2310 comprises a first end 2322 of a monitor bar 2320 coupled to a leg clamp 2330 comprising a first arm 2332 and a second arm 2334. A second end 2324 of the monitor bar 2320 may comprise means for coupling a monitor to the tripod monitor bracket 2310, such as hole 2321. In some implementations, the first end 2322 of the monitor bar 2320 may be coupled to the first arm 2332 of the leg clamp 2330 via one or more fasteners, such as bolts 2323, 2325. The first arm 2332 and the second arm 2334 of the leg clamp 2330 of the tripod monitor bracket 2310 may be coupled via a hinge 2336 with a pin. The interior portion of the first arm 2332 and the second arm 2334 of the leg clamp 2330 may comprise padding 2318 to provide grip.

As shown in FIG. 17, the leg clamp 2330 may further comprise a means for securing the tripod monitor bracket 2310 to the telescoping pole 2200, such as a bolt and knob assembly 2338 with an end cap. The bolt and knob assembly 2338 may be threaded through the first arm 2332 and the second arm 2334 of the leg clamp 2330. The leg clamp 2330 of the tripod monitor bracket 2310 may open and close by pivoting the second arm 2334 of the leg clamp 2330 about the hinge 2336. The second arm 2334 of the leg clamp 2330 of the tripod monitor bracket 2310 may be sufficiently opened to allow the telescoping pole 2200 to be positioned between the first arm 2332 and the second arm 2334 of the leg clamp 2330. The second arm 2334 of the leg clamp 2330 of the tripod monitor bracket 2310 may then be closed around the telescoping pole 2200. To secure the tripod monitor bracket 2310 to the telescoping pole 2200, the bolt and knob assembly 2338 of the leg clamp 2330 of the tripod monitor bracket 2310 may then be tightened by threading the bolt through the first arm 2332 and the second arm 2334 of the leg clamp 2330 as depicted in FIG. 17.

The tripod monitor bracket 2310 may be adjusted vertically along the length of one of the legs 2630 of the tripod attachment 2600 and/or may be rotated vertically about the relevant leg 2630 of the tripod attachment 2600 prior to securing the tripod monitor bracket 2310 to the leg 2630. In some implementations, the monitor bar 2320, the first arm 2332 and the second arm 2334 of the leg clamp 2330 of the tripod monitor bracket 2310 may be made of aluminum. Similarly, the knob and end cap of the bolt and knob assembly 2338 may also be made of aluminum. The padding 2318 on the interior of the first arm 2332 and the second arm 2334 of the leg clamp 2330 may be made of a material such as plastic.

Another implementation of the monitor bracket 2300, such as a monitor bracket similar in form to the monopod monitor bracket 1310 described supra with respect to FIG. 6, may couple to one of the legs 2630 of the tripod attachment 2600.

In various implementations, the telescoping tower system 1000 and/or 2000 are operable to capture video footage and still photographs of desired subject matter from elevated viewpoints. The numerous adjustable components and interchangeable attachments of the telescoping tower system 1000 and/or 2000 allow for customization and adaptability to suit a variety of environments, situations, and user needs. In addition, the modular telescoping tower system 1000 and/or 2000 allow for use across a diverse range of industries. Further, the modularity provides for easier transport, storage, and replacement of components and attachments of the telescoping tower system 1000 and/or 2000. For example, if the first wheel 1540 of the handle bracket 1500 of the telescoping tower system 1000 breaks or malfunctions, a user may simply replace the first wheel 1540 rather than replacing the whole handle bracket 1500 or entirety of the telescoping tower system 1000.

In operation, a user may assemble the telescoping tower system 1000 and/or 2000 to suit his or her needs and/or environment by selecting suitable attachments and adjusting components as necessary. For demonstrative purposes, a possible scenario involving the assembly and operation of the telescoping tower system 1000 will now be discussed. It is to be understood that the telescoping tower system 1000 and/or 2000 may be assembled in a manner different than described. Further, operation of the telescoping tower system 1000 and/or 2000 may vary depending on the user's needs, environment, selection of attachments, and/or adjustments of components.

For example, a user may wish or need to capture video footage or still photographs at heights above twelve (12) feet. As a result, the user may select the telescoping pole 1200 of the telescoping tower system 1000 operable to extend up to twenty-one (21) feet, rather than the telescoping pole 1200 operable to extend up to twelve (12) feet. To assemble the telescoping tower system 1000, the user may attach the selected telescoping pole 1200 to an implementation of the foundation base 1100. The foundation base 1100 chosen by the user may depend on the application. For example, the user may wish to keep the telescoping tower system 1000 stationary and opt to use the swivel base 1110. Alternatively, the user may need to move the telescoping tower system 1000 and choose the manual wheel unit 1130 or the motorized wheel unit 1140. The user may even wish to attach the telescoping tower system 1000 to a bleacher and select the bleacher unit 1120.

Next, the user may attach to the telescoping pole 1200 to the monitor bracket 1300, such as the monopod monitor bracket 1310, and then affix a viewing monitor or device to the monopod monitor bracket 1310. The user may seat his or her camera or recording device on the camera seat 1416 within the camera shield and housing unit 1400. The removable top shield 1420 of the camera shield and housing unit allows the telescoping tower system 1000 to accommodate various types and/or sizes of cameras or recording devices and associated accessories, such as a microphone attachment. If applicable to the user's setup, the user may connect a cable to the selected camera or recording device by putting the cable through the stress relief component 1416 to protect the cable from damage. After seating the chosen camera or recording device, the user may then attach the camera shield and housing unit 1400 to the telescoping pole 1200. The cable may connect the selected camera or recording device to the viewing monitor or device attached to the monitor bracket 1310 of the telescoping tower system 1000, allowing the user to view the images or video footage captured from above in real time or near real time. Alternatively, the camera or recording device may be paired to the viewing monitor or device through wireless means.

Next, the user may select and attach the handle bracket 1500 to the telescoping tower system 1000. A user may opt to use the handle with remote control bar 1502 shown in FIG. 3 to provide the user with greater control over the camera or recording device functionality. For example, the remote control bar 1592 may allow the user to start, stop, zoom in, zoom out, power on, and/or power off the selected camera or recording device from ground level. Alternatively, the user may choose the handle bracket 1500 with a different handle topper 1590, such as the handle bracket with foam bar 1504 shown in FIG. 4. In operation, the handle 1500 provides pan and tilt functionality.

After selecting and attaching the handle bracket 1500, the user may then couple the handle bracket 1500 to the camera shield and housing unit 1400 through the ropes or cords 1541 and 1561 that extend from the first wheel 1540 and the second wheel 1560, respectively, coupled to means for securing, such as carabiners 1482, 1484, which are in turn coupled to the ropes or cords 1473, 1477 extending from the camera shield and housing unit 1400. The self-retracting spring coils 1554 and 1574 within the first wheel 1540 and the second wheel 1560, respectively, engage the ropes or cords 1541 and 1561, providing sufficient tension necessary for the pan and tilt function of the handle 1500. Movement of the handle bracket 1500 causes substantially similar movement at substantially the same time with respect to the camera shield and housing unit 1400. By panning or tilting the handle bracket 1500 in various directions—thereby, panning or tilting the camera or recording device seated in the camera shield and housing unit 1400—the user may capture or record his or her desired subject matter.

Before, while, and/or after capturing or recording video footage or still photographs at elevated viewpoints, the user may elect to set down the telescoping tower system 1000 when not in use via the base holder 1600 as shown in FIG. 9A. The base holder 1600 helps protect the telescoping tower system 1000 and attached components from being damaged and keeps the camera or recording device housed in the camera shield and housing unit 1400 elevated and off the ground. When the user has finished capturing or recording video footage or still photographs, the user may disassemble the telescoping tower system 1000. The modularity of the telescoping tower system 1000 allows for ease of assembly and disassembly as well as storage and transport.

It is to be understood that the terminology used herein is for the purpose of describing particular implementations only, and is not intended to be limiting. As used in this specification, the singular forms “a”, “an” and “the” include plural referents unless the content clearly indicates otherwise. As another example, “coupling” includes direct and/or indirect coupling of members.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A system comprising:
a tower to elevate a camera or recording device, the tower comprising:
a modular foundation base selectively reconfigurable between a swivel base, a manual wheel unit, a motorized wheel unit, and a bleacher unit;
a telescoping pole coupled to the modular foundation base;
a camera shield and housing unit coupled to the telescoping pole; and
a handle coupled to the telescoping pole and the camera shield and housing unit.

2. The system of claim 1, wherein the swivel base further comprises a monopod configuration and a tripod configuration.

3. The system of claim 2, wherein a tripod attachment couples to the telescoping pole in the tripod configuration.

4. The system of claim 1, wherein the telescoping pole comprises:
one or more nested sections and a base section, wherein each of the one or more nested sections is structurally configured to collapse into a wider nested section or the base section, and wherein the base section couples to the modular foundation base.

5. The system of claim 4, wherein the one or more nested sections and the base section extend to a maximum height of 12 feet or 21 feet.

6. The system of claim 1, wherein the camera shield and housing unit comprises a removeable top shield.

7. The system of claim 1, wherein the handle further comprises a modular handle topper selectively configurable between a foam bar and a remote control bar.

8. The system of claim 1, wherein the handle further comprises a first wheel coupled to a second wheel, and wherein each wheel is independently operable and replaceable.

9. The system of claim 8, wherein the first wheel and the second wheel each house a tensioned rope that couples the handle to the camera shield and housing unit.

10. The system of claim 9, wherein rotational movement of the handle pans the camera shield and housing unit.

11. The system of claim 9, wherein vertical movement of the handle tilts the camera shield and housing unit.

12. The system of claim 1, further comprising:
a camera or recording device positioned within the camera shield and housing unit.

13. The system of claim 3, wherein the tower further comprises:
a monitor bracket coupled to the tripod attachment.

14. The system of claim 1, wherein the tower further comprises:
a monitor bracket coupled to the telescoping pole.

15. The system of claim 14, further comprising:
a viewing monitor or device positioned on the monitor bracket, wherein the viewing monitor or device is operatively coupled to a camera or recording device.

16. The system of claim 15, wherein the camera shield and housing unit comprises a stress relief component structured to receive a cable or cord extending between the viewing monitor or device and the camera or recording device and structured to reduce stress on the cable or cord.

17. The system of claim 1, further comprising:
one or more fence clamps to couple the tower to a fence.

18. The system of claim 1, further comprising:
a base holder structured to support the tower in a resting position.

19. The system of claim 18, wherein the base holder is selectively operable between a locked state and an unlocked, folded state.

20. A method of capturing video footage and still photographs from an elevated viewpoint
using the system of claim 12, the method comprising:
attaching the telescoping pole to the selected modular foundation base;
installing the camera or recording device into the camera shield and housing unit;
attaching the camera shield and housing unit to the telescoping pole;
attaching the handle to the telescoping pole and the camera shield and housing unit;
extending the telescoping pole to a desired height;
moving the handle rotationally and/or vertically to pan and/or tilt the camera or recording device; and
capturing video footage or still photographs using the camera or recording device.
